(19) United States
(12) Patent Application Publication
(10) Pub. No.: US 2009/0090044 A1
(43) Pub. Date: Apr. 9, 2009

(54) IN-WALL PEST CONTROL DEVICE

(76) Inventor: Terrence J. Foley, Brooksville, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 12/206,934

(22) Filed: Sep. 9, 2008

Related U.S. Application Data
(60) Provisional application No. 60/978,237, filed on Oct. 8, 2007.

(51) Int. Cl. A01M 1/20

(52) U.S. Cl. 43/131

(57) ABSTRACT

An in-wall pest control device that is used in combination with a wall utility plate adapted to deliver a pest control substance to the interior of a hollow wall. A poison, bait, adhesive, trap and/or lure is affixed to the back of the plate, such that the pest control substance is exposed to the interior of the utility box and/or hollow wall when the plate is affixed thereto. Periodically, the wail plate can be removed for replacement of the pest control substance or the combination of the plate with its pest control substance can be properly discarded and replaced with a new plate/pest control substance device.

### RELATED APPLICATION

This application claims the benefit of U.S. Provisional Application Ser. No. 60/978,237 filed Oct. 8, 2007.

### FIELD OF INVENTION

This invention relates to the field of pest control, in particular, in-wall pest control devices as applied to wall utility plates mounted to utility boxes and the like.

### SUMMARY OF INVENTION

The invention includes an improved wall utility plate (such as for a light switch, electrical socket or the like) adapted to deliver a pest control substance to the interior of a hollow wall. A poison, bait, adhesive, trap and/or lure is affixed to the back of the plate, such that the pest control substance is exposed within the interior of the utility box and/or hollow wall when the plate is affixed thereto. Periodically, the wall plate is removed and the pest control substance can be replaced or the plate can be discarded and replaced with a new one having the pest control substance attached to its back side. As understood by the pest control industry, pest control substances contemplated as being used with the present invention include poison, pesticide, baits, lures, adhesives and traps commonly used or otherwise adapted for typical controlling pests/insects normally found within interior walls. Some may have pesticides better adapted for roaches, other pesticides better suited for ants and silverfish, or other pesticides better suited for spiders, etc. The substance itself may be pre-packaged so the users can merely purchase the appropriate substance and attach it to the back side of the utility box themselves. The manufacturer can pre-package the combination of the substance and wall plate for purchase by the consumer.

In summary, the invention is an in-wall pest control device comprising:

a wall utility plate, said plate having a first side and a second side; and

pest control substance means for attracting and/or killing pest, the pest control substance means being attached to one or more predetermined portions of said second side of said utility wall plate.

The pest control substance means can be selected from the group consisting of poisons, pesticides, baits, lures, adhesives and traps.

The pest control substance means is preferably positioned or otherwise located on one or more portions of the second side of the utility plate so as to avoid interference with a normal operation of the wall utility plate.

The pest control substance means is removably or releasably attached to the second side of the wall utility plate.

### BRIEF DESCRIPTION OF THE DRAWINGS

For a fuller understanding of the invention, reference should be made to the following detailed description, taken in connection with the accompanying drawings, in which:

FIGS. 1A-1E are front views of various examples of illustrative wall plates representative of a typical wall plate contemplated by the present invention;

FIG. 2 is a rear view of one example of a conceptual illustrative embodiment of the invention wherein a bait and trap are affixed to the rear of a light switch plate;

FIG. 3 is a rear view of another example of an alternative embodiment of the invention wherein alternate baits (i.e. ant baits and roach baits) are affixed to the rear of a utility plate, in this case, an electrical socket plate; and

FIG. 4 is a rear view of another illustrative example of another alternative embodiment of the invention wherein a pest lure and glue trap are affixed to the rear of a utility plate, in this ease, a blank wall plate.

### DETAILED DESCRIPTION OF THE INVENTION

In the following detailed description of the preferred embodiments, reference is made to the accompanying drawings, which form a part hereof, and within which are shown by way of illustration of conceptual examples by which the invention may be practiced. It is to be understood that other embodiments may be utilized and structural changes may be made without departing from the scope of the invention.

A great deal of time and energy are spent on indoor pest control. Hollow walls, common in most structures, afford household pests limitless places to hide, live and breed. It is therefore necessary to deliver pest control substances, such as poisons, baits, lures and repellents to the interior of hollow walls. It is preferable that indoor pest control take place with as little disruption to the human habitable areas. In addition to safety, aesthetic functionality is desired.

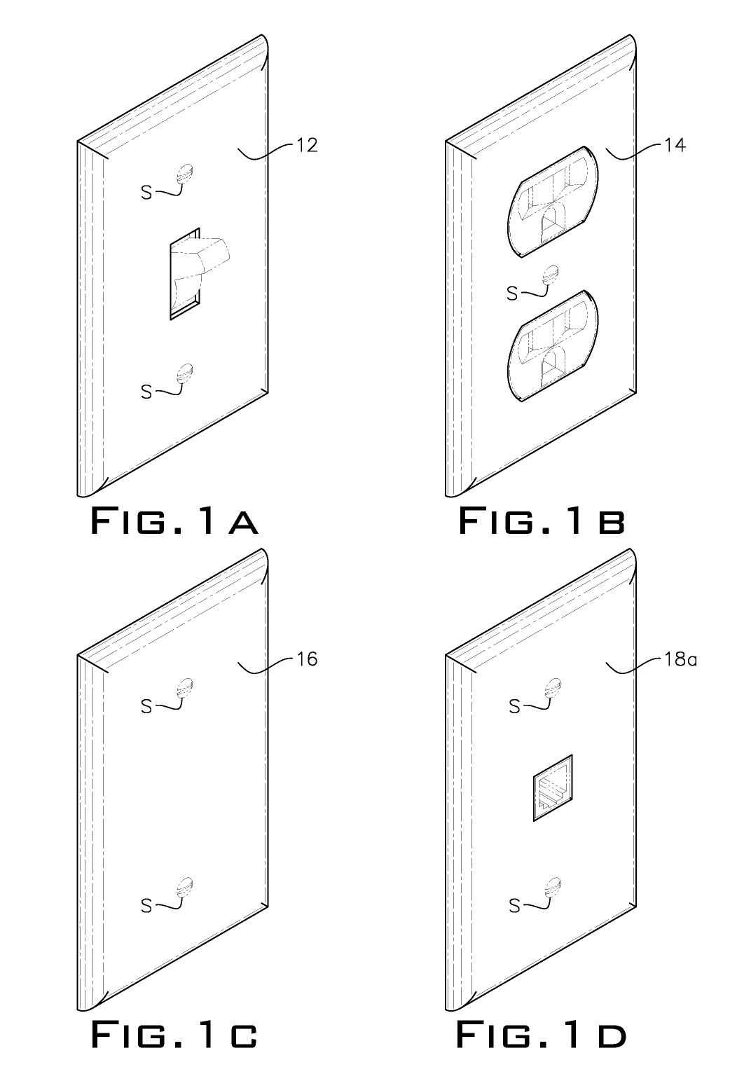

In one example as to how the invention may be practiced, the invention includes an improved wall utility plate (such as for a light switch, electrical socket or the like (see FIGS. 1A-1E) adapted to deliver a pest control substance to the interior of a hollow wall. A poison, bait and/or lure is affixed to the back of the plate, such that the pest control substance is effectively placed within the interior of the hollow wall when the plate is affixed thereto. In this context, the interior of the hollow wall includes the interior of the utility box (not shown) to which the wall plate may be affixed. These utility boxes are not air tight and there are many opening and gaps for pests to enter the box and be attracted to the pesticide present in various alternative forms contemplated by the present invention. Periodically, the wall plate is removed and the pest control substance is replaced or the plate is discarded and replaced with a new one.

As mentioned above, FIGS. 1A-1E represents common wall utility plates found in most buildings. Wall utility plates used with the present invention include, but are not limited to, light switch plates 12, electrical socket plates 14 and blank plates 16 commonly used to cover utility fixtures in a wall which are not operable. Wall utility plates 12, 14, 16, 18a, 18b are usually affixed to a wall by screws “S”. Wall utility plates shown by way of examples are merely representative of several plates that may be used and not necessarily shown, such as cable television jack plates, computer cable jack plates, phone jack plates, audio jack plates, etc. All wall plates used in residences and commercial buildings are contemplated as within the scope of the invention herein.

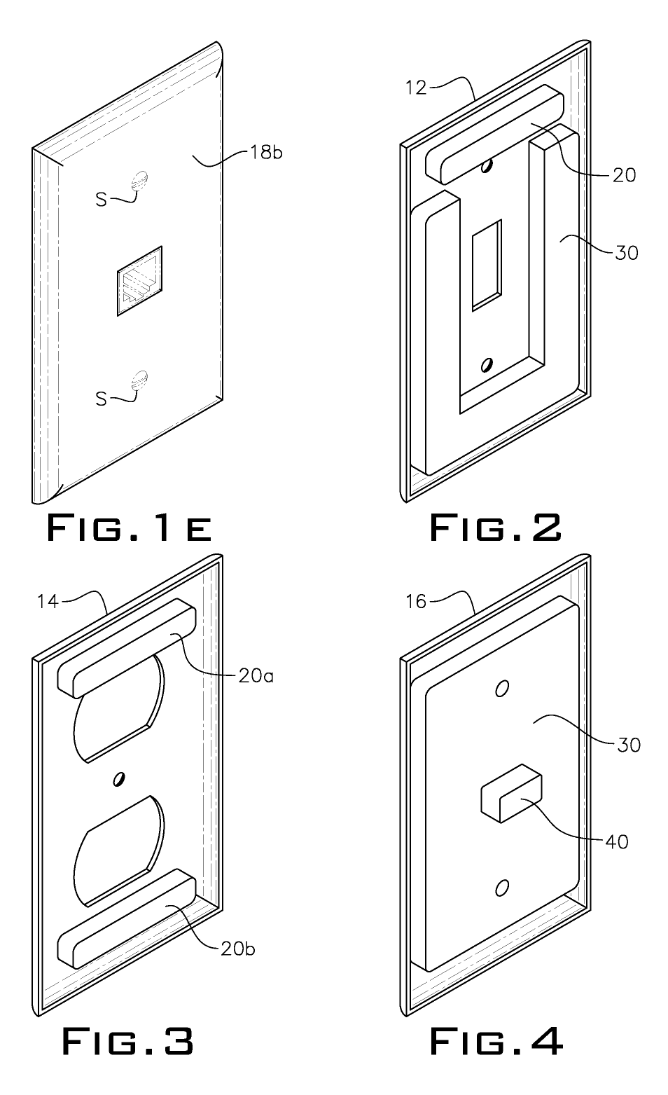

FIG. 2 is a rear view of one example of a conceptual illustrative embodiment of the invention wherein a bait and trap are affixed to the rear of a light switch plate. In the example, a pest control bait (ant bait, roach bait, etc.) 20 is affixed to the rear of light switch wall plate 12. Bait 20 is preferably disposed or located so as to prevent interference with the normal operation of the light switch. In the example of FIG. 2, bait 20 is depicted being used in conjunction with glue trap 30. It is understood that glue trap 30 may be used by itself, or that bait 20 may be used by itself or the combination of such pest control devices. It is also understood that such devices may further include a pesticide component. Glue trap 30 comprises an adhesive substance adapted to capture a pest thereon. Glue trap 30 can be adapted in any configuration which accommodates the functionality of the light switch. Bait 20 and glue trap 30 can be removably affixed to the back of plate 12 using releasable adhesives known in the art, allowing replenishing after expiration. Alternatively, when the pest control substance of bait 20 or glue trap 30 expire, the wall plate can be removed entirely (by removing screws “S”) and replaced with a new plate bearing a pest control substance.

FIG. 3 is a rear view of another example of an alternative embodiment of the invention wherein alternate baits, that is, ant baits and roach baits, are affixed to the rear of a utility plate, in this case, an electrical socket plate. In this alternative embodiment, the pest control substance is disposed on the back of electrical socket plate 14. FIG. 3 illustrates that numerous pest control devices can be used on a single plate. Here, plate 14 is adapted with ant bait 20a and roach bait 20b. As with the previous embodiment, the pest control substance is positioned to avoid interference with the functionality of the wall utility plate.

Lastly, FIG. 4 is a rear view of another illustrative example of another alternative embodiment of the invention wherein a pest lure and glue trap are affixed to the rear of a utility plate, in this case, a blank wall plate 16. This embodiment provides the maximum surface area for the placement of the pest control substance. In the conceptual example shown in FIG. 4, blank plate 16 is equipped with glue trap 30 disposed on the back side thereof. Lure 40 is placed in the middle of glue trap 30 to entice pests. The adhesive of glue trap 30 can be placed directly on the backside of plate 16 or can be placed on a backer (not shown) which allows the trap to be removed without the need to replace plate 16.

FIGS. 2 through 4 show conceptual representative example of how to implement the present invention. The position and selection of pest control substances are provided by way of example. Numerous combinations of pest control substances, as well arrangement thereof, are envisioned and fall within the scope of the invention. One of skill in the art will appreciate what pest control substances, as well as the arrangement thereof are suitable for specific pest or for specific situations. It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as conceptually illustrative and not in a limiting sense. It is also to be understood that the following claims are intended to cover all of the generic and specific features of the invention herein described, and all statements of the scope of the invention which, as a matter of language, might be said to fall there between.

What is claimed is:

1. An in-wall pest control device comprising:
a wall utility plate, said plate having a first side and a second side, and
pest control substance means for attracting and/or killing pest, said pest control substance means being attached to one or more predetermined portions of said second side of said utility wall plate.

2. The device of claim 1, wherein said pest control substance means is selected from the group consisting of poisons, pesticides, baits, lures, adhesives and traps.

3. The device of claim 1, wherein said pest control substance means is located on one or more portions of said second side of said utility plate so as to avoid interference with a normal operation of said wall utility plate.

4. The device of claim 1, wherein the pest control substance means is removably attached to said second side of said wall utility plate.
